(19) United States
(12) Patent Application Publication
(10) Pub. No.: US 2014/0232272 A1
(43) Pub. Date: Aug. 21, 2014

(54) LED LIGHTING SYSTEM

(71) Applicant: C2 DEVELOPMENT, INC., Ames, IA (US)

(72) Inventor: Christian James Clough, Ames, IA (US)

(73) Assignee: C2 DEVELOPMENT, INC., Ames, IA (US)

(21) Appl. No.: 13/771,468

(22) Filed: Feb. 20, 2013

(51) Int. Cl. H05B 37/02

(52) U.S. Cl. CPC H05B 37/02
USPC 315/129; 315/294

(57) ABSTRACT

A controller for a system is provided. The controller includes an intelligent control having a memory and a wireless transceiver. The controller is synced with a system, such as a lighting system, wirelessly. The wireless connection provides constant feedback between the controller and the system such that the controller is able to control operation of the system, to receive feedback from the system, and to receive updates based on changes to the system. The system includes modular components that may be easily configurable and changeable. The modular components are automatically identified by the system and the new information is automatically sent to the controller to update the controller of a change to the system.

### FIELD OF THE INVENTION

The present invention related generally to lighting systems. More particularly, but not exclusively, the system relates to a controller for syncing with a lighting system that can wirelessly control aspects of the system and can automatically detect changes to the lighting system.

### BACKGROUND OF THE INVENTION

Lighting systems, such as a lighting system configured for use with aquariums and the like, are used to provide light for the interior of the aquarium. Some systems have been configured to have certain lighting programs, such as illuminating and dimming at certain times. For example, in order to provide a near realistic environment for the aquarium, the lighting system may be configured to begin illumination and dimming in accordance with the daily sun cycle. Thus, the lights will gradually illuminate in the morning to coincide with the rising of the sun, and will begin gradually dimming in the evening, to mimic the sun setting.

However, while the programs may be controlled via a controller, either connected or wireless, they systems are still limited. For example, most lighting systems include preset colors and configurations for the lights. These lights are not able to be replaced without having to replace the entire system. In addition, even if the lights are replaced, the systems are not configured to automatically determine the new lighting configurations and/or colors, and to update the controllers regarding the same.

Furthermore, the controllers used for the systems are rather limited. While they are able to wirelessly control specific aspects of the lighting systems, they are not able to receive feedback from the system or an environment adjacent the lighting system. Furthermore, the controllers are not able to be used with other electronic systems to control, receive feedback, and automatically update the systems or components thereof based upon changes to the system or environment.

Therefore, what is needed is a lighting system or other electronic system, and a controller connected thereto, in which the controller is able to sync with the system such that it can control the system, as well as receive feedback from the system based upon environmental or other changes to provide an alert at the controller or to automatically adjust an aspect of the system based upon the change.

### SUMMARY OF THE INVENTION

Therefore, it is a primary object, feature, and/or advantage of the present invention to provide an apparatus that overcomes the deficiencies in the art.

It is another object, feature, and/or advantage of the present invention to provide a controller for a lighting system that can wirelessly sync with the system to control and to receive feedback from the system.

It is yet another object, feature, and/or advantage of the present invention to provide a lighting system that will automatically determine a change in a modular component of the system.

It is still a further object, feature, and/or advantage of the present invention to provide a controller that will alert a user via user interface of a change related to a system.

It is a further object, feature, and/or advantage of the present invention to provide a controller that is synced with a system to automatically provide new choices based upon a change to the system.

It is still a further object, feature, and/or advantage of the present invention to provide a lighting system for an aquarium that is controlled via a wireless controller.

It is yet a further object, feature, and/or advantage of the present invention to provide a lighting system that automatically adjusts a program of the lights of the system based upon a change to a modular light component of the system.

These and/or other objects, features, and advantages of the present invention will be apparent to those skilled in the art. The present invention is not to be limited to or by these objects, features and advantages. No single embodiment need provide each and every object, feature, or advantage.

### BRIEF DESCRIPTION OF THE DRAWINGS

FIG. 1 is a perspective view of a lighting system according to an embodiment of the present invention.

FIG. 2 is a top plan view of the lighting system of FIG. 1.

FIG. 3 is a schematic of a lighting system according to an embodiment of the present invention.

FIG. 4 is a perspective view of an embodiment of a controller for use with the lighting system of FIG. 1.

FIG. 5 is a perspective view of a controller according to an embodiment of the invention wherein the controller comprises a phone.

FIG. 6 is a diagram of a method of syncing sequences for a controller for a system of the invention.

FIG. 7 is a block diagram of a controller and system of the present invention.

### DETAILED DESCRIPTION OF THE PREFERRED EMBODIMENTS

The invention relates to a system comprising a controller and a component synced with the controller. For example, the component may be a lighting system or other electronic system that is controlled wireless via the controller. In addition, the component may include modular items that can be easily replaced and reconfigured. An aspect of the invention contemplates that the component will wirelessly indicate to the controller that a change has been made to one or more of the modular items of the component. The controller will then automatically update itself to provide new options of control, e.g., programs, settings, etc., based on the information received from the component. As will be understood, the system will provide numerous benefits to various fields, and the uses illustrated herein are for exemplary purposes only.

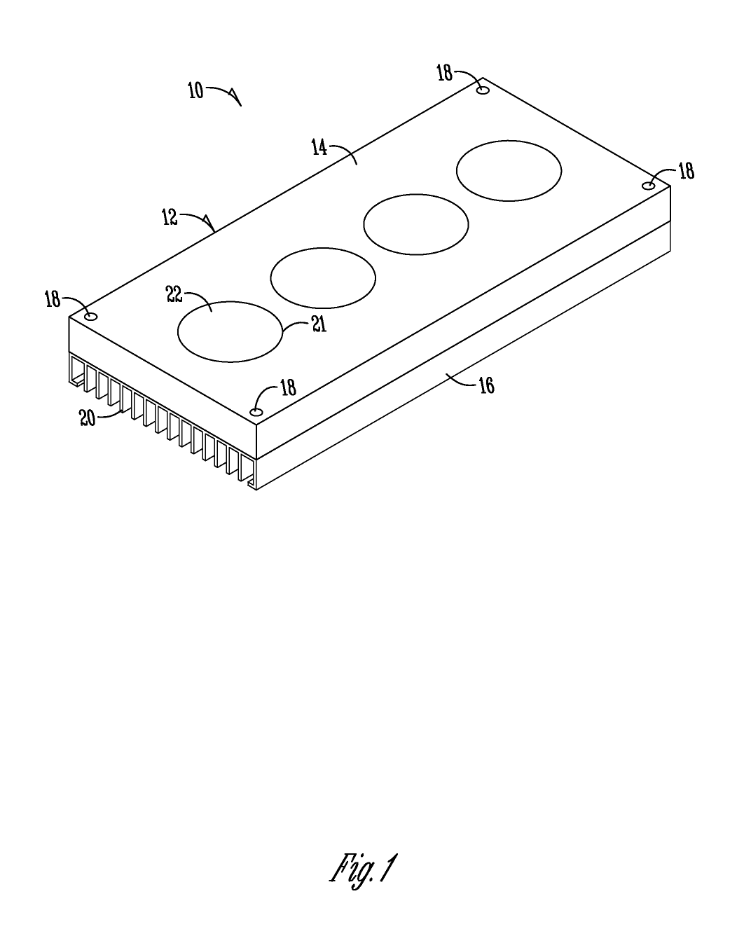

FIG. 1 is a perspective view of a lighting system 10 according to an embodiment of the invention. The lighting system 10 shown in FIG. 1 is an example of one of the components discussed above. As will be discussed below, the lighting system 10 will include components that can be rearranged, reconfigured, replaced, or the like. The lighting system 10 will then wirelessly connect to a controller to indicate to the controller that a change has been made. The feedback received by the controller will update the controller to operate the lighting system 10 remotely.

The lighting system 10 shown in FIG. 1 includes a housing 12. The housing may comprise first and second sections 14, 16 connected via attachments 18. The attachments 18 may be screws, adhesive, snaps, Velcro, or the like. Furthermore, the housing 12 may include only one piece with removable aspects in order to provide access to the interior of the housing. The second section 16 of the housing 12 includes a plurality of fins 20. The fins 20 are positioned adjacent a fan (not shown) on the second section 16. The fan and fins are used to cool the interior of the lighting system 10, and provide a heat sink for lights housed therein. Other aspects or methods of cooling the interior of the lighting system 10 are contemplated as well.

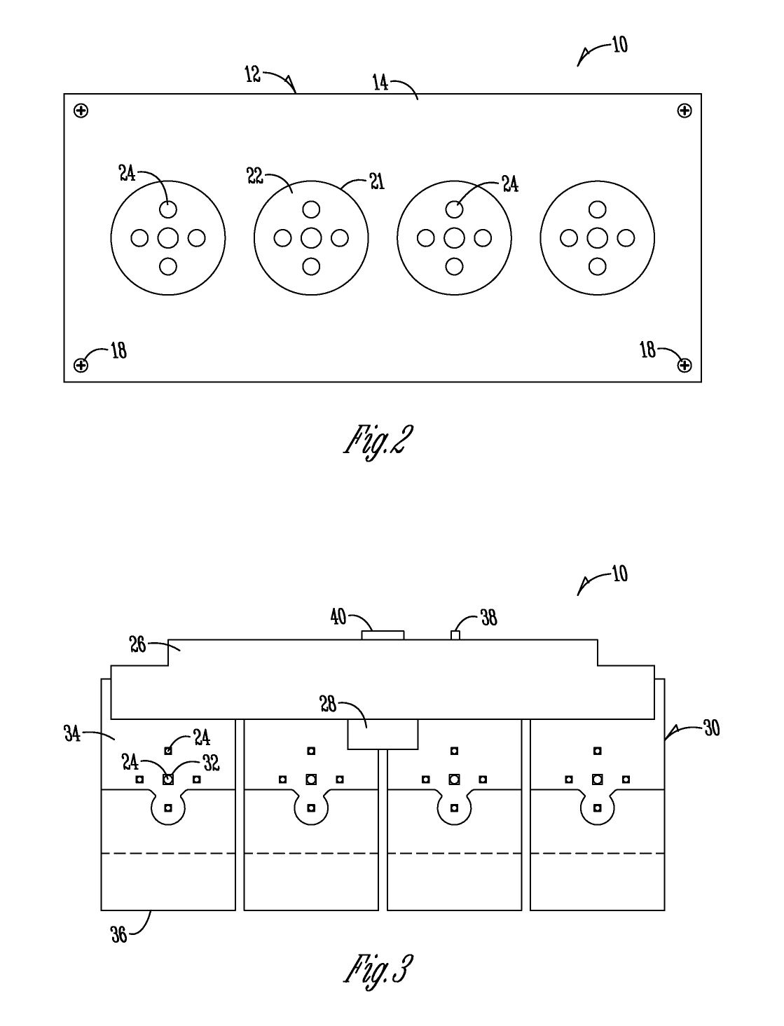

The first section 14 of the housing 12 includes a plurality of apertures 21 therethrough. The apertures 21, as shown in FIG. 2, are aligned such that lights housed within the housing 12 can illuminate through the apertures 21. In addition, a lens 22 is placed within the aperture 21 of the section 14 to protect the lights 24 and to provide lighting effects. Therefore, the lenses 22 may comprise a clear material or may include a color or lighting effect to adjust the illumination or display of lights 24 through the lenses 22.

FIG. 2 is a top plan view of the lighting system 10 of FIG. 1. As discussed, a plurality of lights 24 will be housed within the housing 12 of the system 10. The lights 24 comprise light emitting diodes (LEDs). The LED lights are shown in a configuration wherein one central light is surrounding radially by four other lights. However, the invention contemplates that any configuration of the lights is to be included as part of the present invention. In addition, the number of lights positioned adjacent to the lens may be varied as well. The lights 24 of the invention may comprise a plurality of colors. For example, the colors may provide different lighting effects for the lighting system 10. The colors may be used to replicate a naturally occurring effect, such as sunrise or sunset. For example, the lights 24 of the lighting system 10 may be programmed to gradually increase in illumination to coincide with the sunrise of the day. In addition, the lights will gradually dim at the time of sundown or sunset to replicate the end of the day. As the lighting system 10 may be used with an aquarium or other interior function, the replication of sunrise and sunset may provide some sense of reality to animals housed within the aquarium. In addition, the light could be used as an alarm for a person such that the gradual illumination of the light will provide a more gentle awakening for an individual.

As discussed, the lights may be programmable such that they can perform any function. The light 24 may be configured such that they provide a replication of sunrise and sunset. In addition, the lights may be programmed to intermittently illuminate such that a lighting effect is provided. For example, as the lights 24 may comprise various colors, a program may be set such that the lights are cycled through the various colors to provide a pleasing or entertaining display. The lights may also be used to obtain information, which can be submitted to a controller.

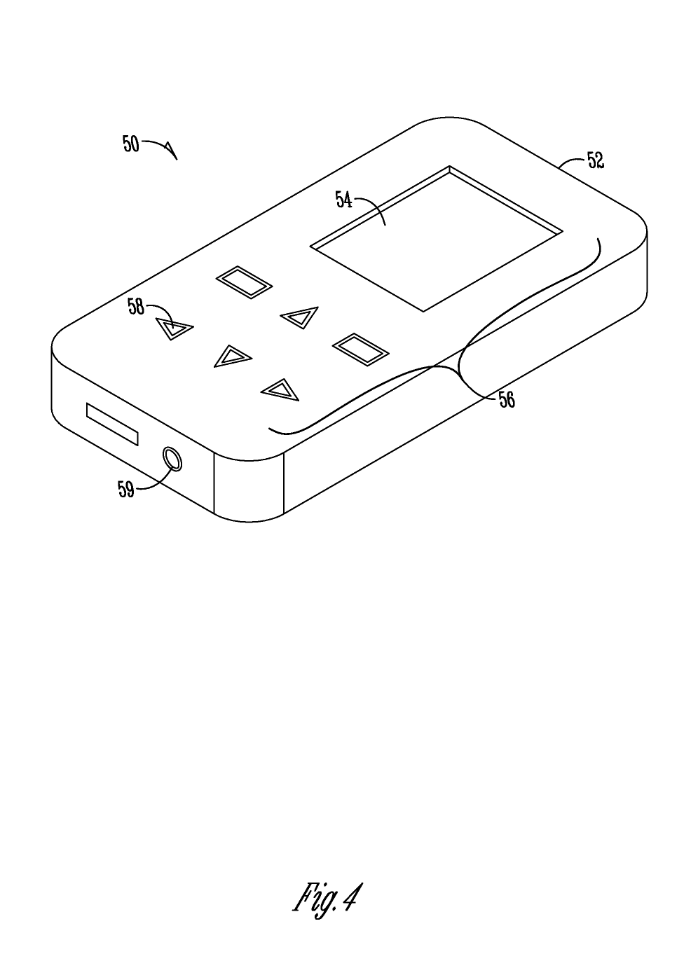

FIG. 3 is a schematic of the interior of the lighting system 10 according to an embodiment of the present invention. A main board 26 is provided which includes electrical components such as wiring and other circuitry. Connected thereto is an intelligent control 28 which may also be considered a master module. The intelligent control 28 can include memory and a wireless transceiver therein. The intelligent control 28 may also include other functionalities. Also attached to the main board 26 and electrically coupled to the intelligent control 28 is a plurality of modular components 30. The modular components 30 include the plurality of lights 24 positioned thereon. The lights 24 shown in FIG. 3 correspond to the lights 24 shown in FIG. 2. Thus, the lights 24 may be configured in any configuration and may include any number or variety of colors. The modular components 30 also include a plurality of resistors 32 positioned adjacent the lights 24 and connected to a sub straight 34 of the component 30. The resistors 32 correspond with the type, color, intensity, etc. of the light 24 positioned thereon.

One aspect of the invention provides that the modular components may be replaceable, and interchangeable. For example, while the system 10 may be provided with a certain configuration of modules 30 having configuration on color of lights thereon, a user may want to change out one or more of the components 32 to provide a more personalized lighting system 10. Therefore, the modular components 30 may be easily removed from the main board 26 and replaced with a personalized component 32. Thus, the invention contemplates that the lighting system of FIGS. 1-3 may be personalized in any manner.

Another aspect of the invention provides that the lighting system 10 will automatically identify a change to one or more of the modular components 30. This is done with the addition of a plurality of drivers 36 electrically coupled to the modular component 30. The drivers 36 include a memory having a database comprising a near limitless number of possible configurations of the light for the modular components 30. Therefore, when a new modular component 30 having a personalized configuration of lights 24 thereon is attached to the main board 26, the driver will interact with the resistors 32 adjacent the lights 24 to identify the configuration of lights thereon. The driver 36 will then communicate this information to the intelligent control 28 of the lighting system 10. The intelligent control, as will be discussed below, will then wirelessly transmit the information of the new modular component 30 to a controller in the form of feedback. The controller will then either provide the information to a user via a display, or will provide new programs, or other possibilities of use for the updated lighting system based on the new configuration of lights 24 for the modular component 30.

Other aspects of the lighting system 10 shown in FIG. 3 may include a power button 38 and a power source 40. The power button 38 is used to turn the lighting system on and off and also to shuffle the lighting system to a display configuration wherein the lighting system shuffles through the lighting combinations of the lights 24 of the modular components 30. The power source 40 may be in the form of an electrical hookup such that a power cord may be attached thereto to provide power to the lighting system 10. In addition, the power source may be a battery, such as a rechargeable battery, such that the lighting system may initially need to be plugged in to charge the battery. However, after certain amounts of charging, the system may be used in a location where no outlet is available. In addition, instead of light or in addition to the lights 24 of the lighting system 10, sensors 42 may also be provided with the modular component. The sensors may sense a position such as they proximity sensors, may obtain information relating to the environment, or the like. For example, the sensors may include pH sensors such that they are able to indicate the pH of the water in an aquarium to provide feedback to the controller. In addition, the sensors may be proximity sensors such that they determine the distance between the sensors and the water in the aquarium such that they can alert a user if there is a change in the depth of water. Other sensors may include thermal sensors, olfactory sensors, accelerometers or the like. The included list is not to be an exhaustive list of possible sensors for use with the system 10.

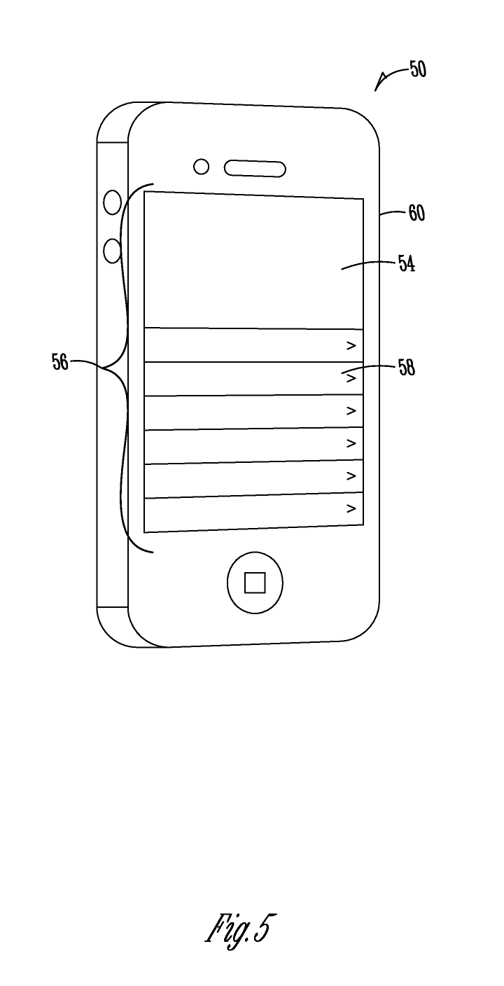

As discussed, the system 10 may be synced wirelessly with a controller 50. One exemplary embodiment of a controller 50 is included in FIG. 4. The controller of FIG. 4 generally includes a housing 52. A display 54 is housed within the housing 52. In addition, a user interface 56, which may include the display 54 is also included in the housing 52. The user interface 56 may also include a plurality of buttons or controls 58 thereon. The buttons and controls will work with the display to allow a user to input an action for the controller. Thus, the buttons 58 may be scroll and input buttons such that they input a program through the controller for the light system. For example, the controller may be used to set up a program related to the times for the sunrise and sunset example, as discussed above. A user may view the possible inputs at the display 54 and adjust the inputs and input desired information via the buttons 58. The controller 50 may also include ports 59 such as a power or charging port.

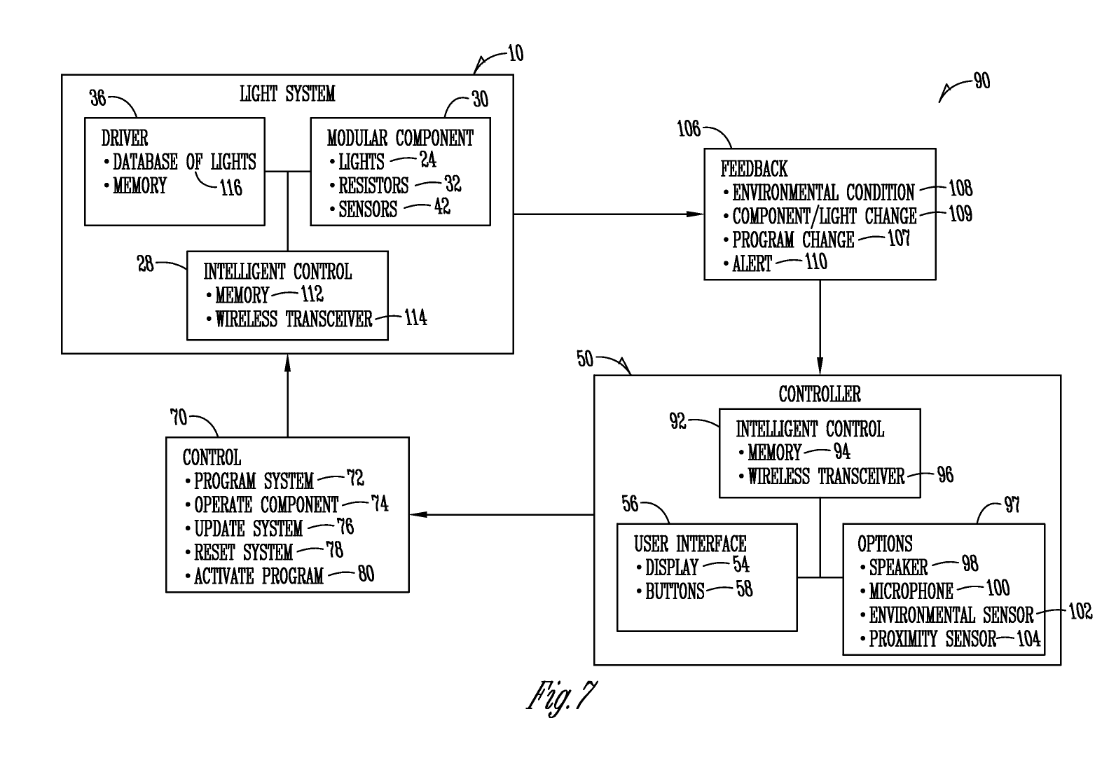

As is discussed below, the controller 50 includes an intelligent control including a memory and a wireless transceiver. The wireless transceiver of the controller 50 is used to sync the controller with the system, such as the lighting system 10 as described above. For example, as shown in FIG. 6, one method of syncing a controller 50 with a system 10 may be shown. After powering on the system 10 and the controller 50, a user initiates a discover request via the controller 50. This indicates to the controller to wireless send a signal, such as a discovery signal to the surrounding area. The controller waits to see if a response is received from any components or systems. If no response is received, either no systems are in the proximity or multiple systems responses have collided in the air. Therefore, the controller may, after a period of time, send another discovery request. If a system receives response, the controller will then send a claim request to the system. The claim request is information related to the system in the controller such that they are able to sync to one another. The controller then waits to see if the request is received by the system via a returned response. If no response is received, the system goes back to initiating another discovery request. However, if the request is received via the controller from the system, the controller and the system will then sync to one another. The syncing of the controller and the system or component will then allow the controller 50 to perform various functions or to control various aspects of the system wirelessly. For example, the controller may be used to change an environmental condition of the system, to change a component of the device, or to change a program of the device. For example, the controller 50 may be used to change the display or intensity of the lighting system 10 shown in FIG. 1. The controller may also be used to simply turn the lighting system 10 on or off.

In addition, the lighting system 10 may be used to send feedback to the controller 50. For example, as noted above, the lighting system 10 includes a plurality of modular components such that the user is able to reconfigure or change out one or more of the modular components. If done, the system 10 will now include a new or reconfigured plurality of lights. The intelligent control 28 of the lighting system 10 will then wirelessly send feedback to the controller 50 alerting the controller that a new configuration is included. The controller will display this new information via the display 54 on the user interface 56 of the controller 50. A user is then able to reprogram the device or to perform a new configuration based on the new aspects of the modular component 30. For example, if the new modular components includes sensor, the controller will allow the user to manipulate the sensor or to program the sensor to provide certain information. For example, if a pH sensor is included in the new modular component, the user may be able to program the controller to have the system 10 to send an alert to the display 54 of the controller 50 once the pH has risen or dropped below a certain allowable range. Thus, the controller may provide an audible noise, or simply change the display thereon to alert a user that the pH has changed outside the allowable range. Other aspects of the modular components will provide for additional options for the controller.

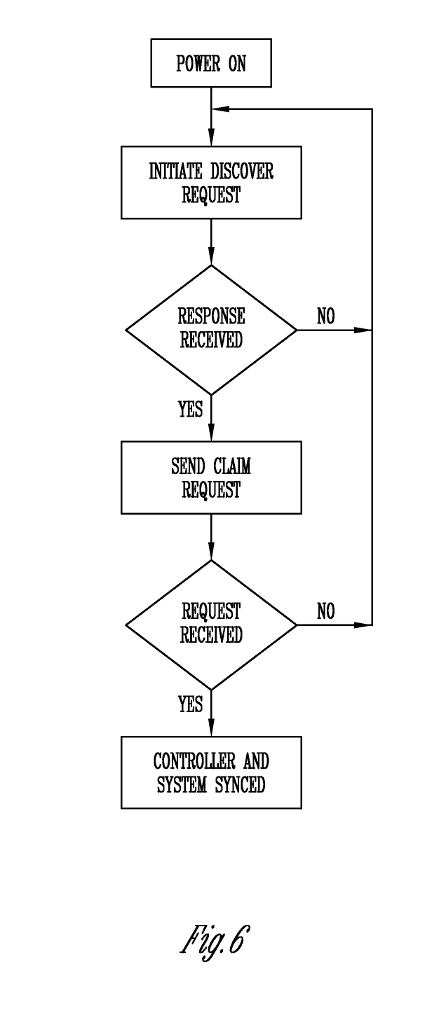

FIG. 5 is a perspective view of another embodiment of controller 50 wherein the controller apprizes a program or application on a bone 60. The invention contemplates that the controller need not be its own independent device. Instead, the controller may be uploadable, downloadable, or otherwise installable program such that it can be used on existing cellphones, tablets, computers, or other computing devices. For example, as shown in FIG. 5 a cellphone 60 includes a downloadable application which in turn becomes the de factor controller 50. Similar to FIG. 4, the controller 50 shown in FIG. 5 includes a user interface 56 including a display 54 and plurality of buttons or controls 58. However, in the embodiment shown in FIG. 5, the buttons or controls are not separated or independent components. Instead, as shown in FIG. 5, the buttons are simply shown on the touchscreen such that they coincide with the touching of the display 54 of the phone 60. However, the controller 50 of FIG. 5 may be utilized in the same way as that of the controller in FIG. 4. The use of the application on a phone or other computing device having a wireless capability may provide for more remote access of the controller. For example, while most people carry their phones wherever they go, the phones may be utilized to allow a user to reprogram, update, or check in on the system in the area where the system is located. For example, the use of the controller on a phone may allow a user to check the operating perimeters, or environment conditions of an aquarium even in another state or time zone. The display will simply receive feedback from the system 10 to provide the user with information relating to the system. For example, the display may indicate the level of pH in an aquarium or may indicate the status of the lights at the system 10. A notification or alert may also pop up to alert the user that a change a condition of the system has occurred. For example, a notification may alert the user if a light needs to be replaced, if an environmental condition has changed, if something has been tampered with, or even if the system no longer has power thereto. The exact number and types of alerts or feedback received by the controller are near limitless.

FIG. 7 is a block diagram of the schematic of a controller and system according to an embodiment of the present invention. As discussed, the lighting system 10 shown in FIG. 1 may include an intelligent control 28, one or more modular components 30, and one or more drivers 36 electrically coupled to the component 30 and intelligent control 28. The intelligent control 28 may include memory 112 and a wireless transceiver or high speed bus. The memory may include any type of memory and may be used to store the type and configuration of the modular components attached thereto, as well as to store information relating to the programming of the lighting system 10.

The modular components may include a plurality of lights 24 and resistors 32 connected thereto. The resistors are red by the driver 36 to indicate to the intelligent control the type, color, and configuration of the lights on the modular component 30. In addition, the modular component may include one or more sensors 42 also attached to the resistors 32. The sensors 42, similar to the lights 24, may include any configuration and type. The resistors 32 attached to the sensors 42 will indicate to the driver the type, location and type of sensor on the modular component. For example, the sensors may include thermal sensors, environmental sensors (such as pH sensors), speakers or other audio sensors, olfactory sensors, accelerometers, or the like. The sensors are used to obtain information related to the system 10. The driver 36 includes a database 116 related to the possibilities for the modular components 30. Therefore, the database 116 of the drivers 36 contains nearly an infinite number of possibilities or configurations for items positioned on the modular components, such as sensors and lights. Therefore, when a modular component is connected to the system, the driver will read the elements of the modular component and in turn communicate the information to the intelligent control. The intelligent control then stores the configuration of the modular components at its memory, and also can communicate this information wirelessly to a controller.

The system 90 shown in FIG. 7 also includes a controller 50. As discussed, the controller includes an intelligent control 92, which may comprise a memory 94 and a wireless transceiver 96. The memory is used to store information, such as time, programs, and the configuration of the system 10. The controller 50 also includes a user interface 56, which may include a display 54 and buttons 58. The display displays information related to the system and/or controller. The buttons are used to manipulate the controller such that the controller and/or system may be reconfigured or changed based on inputs of the user via the buttons 58.

Other options 97 for the controller may include a speaker 98, microphone 100, environmental sensor 102 or proximity sensor 104. It is noted that this not an exhaustive list of possible options for the controller, and other items may be included for the controller.

As shown by the arrows in FIG. 7, the system 10 and the controller 50 are in constant communication with one another to provide controls 70 or feedback 106 to one another. For example, as indicated above, a user is able to input information to the controller 50 based on information or feedback received from the light system. The control 70 may include program information 72, operating information 74, updating information 76, resetting information 78 or activating information 80. For example, a user may set up a program in the controller, such as a lighting program. The controller then sends this information to the lighting system wherein the lighting system receives this information to operate the program at the inputted times. The controller may also use this to simply operate the component, such as by turning on elements of the component.

In addition, the system 10 is in communication with the controller 50 to provide feedback 106 thereto. For example, the feedback may include information such as environmental conditions 108, changes in the components or lights 109, changes to a program 107, or alerts 110. As noted above, once a program has been set and communicated to the system 10, if a change occurs at the system (i.e., a light burns out) the system will send an alert to the controller. The alert 110 can be displayed via the display 54 of the controller to indicate to the operator or user that something has occurred at the system 10. Thus, the user will then know to check on the system at the next available time or to replace a component thereof. Other types of alerts may include a change in environmental condition, such as temperature or pH reading of a system.

The system has been described in relation to a lighting system for use with an aquarium. For example, the lighting system shown in FIG. 10 may be positioned at an aquarium such that it provides light or lighting effects thereto. The system may also include sensors for reading environmental conditions of the aquarium. Therefore, once a controller is synced with the lighting system in the aquarium, the controller is able to program, change program, or simply read information of the aquarium remotely from the aquarium. For example, an operator may check on aspects of the aquarium while in another city, state, or even country, as long as both the system and the controller have wireless access. The operator is then able to adjust the lighting system based upon the information received or feedback received from the system. However, other uses for a system including a controller and a separate component providing feedback to the controller are also included and contemplated by the invention. For example, the system 10 may comprise wireless water chemistry probes that are water tight and/or sealed with a battery that lasts as long as the probe for easy replacement. The controller may be used to read information for the probes and to change allowable or acceptable ranges of chemistry for the probe readings. The probes can also send alerts to the controller to indicate that a change or a condition has occurred at the aquarium.

The controller may also be utilized such that the system is components of a house such that the home is automated via the controller. For example, the controller may include such information such as an audio amplifier, microphone, temperature sensor, proximity sensor, and wireless communication. Using this wireless communication, such as Bluetooth, the system, in this case the house itself, can determine the location of the controller and can transfer information, such as audio, temperature, etc. accordingly. For example, the system may be a plurality of televisions interconnected. If the user has a controller on him or her, and is watching a show on a television in one room, and decides to go to another room, the controller will not this change in location and can automatically turn on the television in the second room to the television program that was in the first room. In addition, the system can be used to change the climate in individual rooms based upon a user's preference for individual controllers. The system can also be used to change the lighting such that lighting may become dim or brightened based upon the user's preference when the user and controller enter certain rooms. Other uses for the house being the system and controller in sync therewith to control aspects of the house are also included in the present invention. Yet another aspect of the invention provides the system being sensors for the oil or gas industry. The system including the sensors can be positioned such that they are under the ground in a location that is not safe for humans to venture. However, the sensors, which are synced to a controller, can provide feedback from the sensors to a human in a safe location outside the drilled hole to indicate conditions within the hole. Thus, the sensors may provide pressure readings, chemistry readings, or other environmental conditions. These readings can be displayed at the controller to indicate the conditions such that the operator can then determine whether to proceed with drilling or to change an aspect of the drilling.

As can be seen, virtually any use for a system being in constant communications with a controller are contemplated by the present invention. The present invention provides numerous advantages over the art. The invention contemplates a controller being in constant communication with the system such that the controller is able to receive feedback and provide input to the system. Thus, the controller is able to receive alerts based on the change to the system and can update as needed. In addition, the controller would be able to determine change to a component of the system automatically and to provide new options based on the change to the system. In addition, the system provides modular components that are easily replaceable and interchangeable such that the system can be configured for many uses in a quick and efficient manner.

The foregoing description has been presented for purposes of illustrating and description, and is not intended to be an exhaustive list or to limit the invention to precise forms disclosed. It is contemplated that other alternative processes and apparatuses obvious to those skilled in the art are considered to be included in the invention. The description is merely examples of embodiments. It is understand that any other modifications, substitutions, and/or additions may be made that are within the intended spirit and scope of the invention. From the foregoing, it can be seen that the present invention accomplishes at least all of the stated objectives.

What is claimed is:

1. A controller for a system, comprising:
an intelligent control including a memory and a wireless transceiver; and
a user interface connected to the intelligent control;
wherein the user interface is configured:
a. to control operation of at least one component of the system;
b. to receive feedback from at least one component of the system and to display the feedback; and
c. to automatically receive information about a change to at least one component of the system and to reconfigure the control and feedback accordingly.

2. The controller of claim 1 wherein the at least one component comprises a lighting device comprising:
a. an intelligent control;
b. a plurality of modular lighting components connected to the intelligent control, each component comprising a plurality of lights; and
c. a plurality of drivers connected to and comprising information related to the modular lighting components.

3. The controller of claim 2 wherein the user interface of the controller is configured to:
a. control operation of the lights of at least one of the modular lighting components;
b. receive feedback from the lighting device; and
c. automatically receive information from a change in at least one of the modular lighting components.

4. The controller of claim 3 wherein the controller comprises a phone.

5. The controller of claim 3 wherein the controller comprises a tablet.

6. The controller of claim 3 wherein the controller comprises a computer.

7. The controller of claim 1 wherein the feedback from the system comprises an environmental condition for the system.

8. The controller of claim 1 wherein the controller comprises an application for a phone, tablet, or other computing device.

9. The controller of claim 1 further comprising:
a. an audio amplifier;
b. a microphone;
c. an environmental sensor; or
d. a proximity sensor.

10. A method of controlling a device with a wireless controller, comprising:
providing a wireless controller having a wireless transceiver;
initiating a wireless discover request by the controller wherein the controller sends a signal for a predetermined amount of time;
receiving a device signal from a device based upon the sent signal; and
sending a claim request to the device to sync the controller with the device to allow a user interface of the controller to control an operation of the device.

11. The method of claim 10 further comprising initiating a plurality of discover requests to sync the controller with multiple devices.

12. The method of claim 10 further comprising resending the discover request if no device signal is received after the predetermined amount of time.

13. The method of claim 10 further comprising receiving feedback at the user interface of the controller from the device based upon a change noted by the device.

14. The method of claim 13 wherein the change noted by the device comprises:
a. a change in an environmental condition;
b. a change in a component of the device; or
c. a change in a program of the device.

15. A controller for controlling a synced lighting device, comprising:
an intelligent control including a memory and a wireless transceiver; and
a user interface connected to the intelligent control;
wherein the lighting system comprises:
a. an intelligent control;
b. a plurality of modular lighting components connected to the intelligent control, each component comprising a plurality of lights; and
c. a plurality of drivers connected to and comprising information related to the modular lighting components; and
wherein the user interface of the controller is configured to:
a. control operation of the lights of at least one of the modular lighting components; and
b. receive and display feedback from the lighting device.

16. The controller of claim 15 wherein the plurality of lights are LED lights, and wherein the modular lighting components further comprise a plurality of resistors associated with the LED lights.

17. The controller of claim 16 wherein the driver includes a database of possible configurations for the lights of the modular lighting components.

18. The controller of claim 15 wherein the controller comprises an application for a phone, tablet, or other computing device.

19. The controller of claim 15 wherein the feedback received and displayed by the user interface comprises:
a. a change in an environmental condition;
b. a change in the configuration of the modular lighting component; or
c. an alert from the lighting system.

20. The controller of claim 19 wherein the drivers of the lighting system detect a change to the modular lighting component, determine the change based upon a stored database, and direct the change wirelessly via the lighting system intelligent control to the controller.
